(19) United States
(12) Patent Application Publication
(10) Pub. No.: US 2026/0132299 A1
(43) Pub. Date: May 14, 2026

(54) COATED ZIRCONIUM NITRIDE PARTICLE AND UV-CURABLE BLACK ORGANIC COMPOSITION

(71) Applicants: MITSUBISHI MATERIALS CORPORATION, Tokyo (JP); Mitsubishi Materials Electronic Chemicals Co., Ltd., Akita-shi (JP)

(72) Inventors: Hiroto Akaike, Naka-shi (JP); Norihisa Chitose, Naka-shi (JP); Kensuke Kageyama, Akita-shi (JP); Takuya Shiyama, Akita-shi (JP)

(73) Assignees: MITSUBISHI MATERIALS CORPORATION, Tokyo (JP); Mitsubishi Materials Electronic Chemicals Co., Ltd., Akita-shi (JP)

(21) Appl. No.: 18/695,503

(22) PCT Filed: Sep. 26, 2022
(86) PCT No.: PCT/JP2022/035691

§ 371 Date: Mar. 26, 2024

(30) Foreign Application Priority Data
Sep. 27, 2021 (JP) 2021-157126

(51) Int. Cl. C09D 7/62; C08K 3/28; C09C 1/56; C09D 17/00

(52) U.S. Cl. CPC C09D 7/62; C08K 3/28; C09C 1/56; C09D 17/004

(57) ABSTRACT

The coated zirconium nitride particle of the present invention contain zirconium nitride particles, an oxide layer covering at least a part of a surface of the zirconium nitride particles, and fine carbon particles scattered on a surface of the oxide layer or in the oxide layer, in which a content of a surface-adhered carbon is in a range of 0.10% by mass or more and 5.0% by mass or less.

### TECHNICAL FIELD

The present invention relates to a coated zirconium nitride particle and a UV-curable black organic composition.

Priority is claimed on Japanese Patent Application No. 2021-157126, filed on Sep. 27, 2021, the content of which is incorporated herein by reference.

### BACKGROUND ART

An insulating black pigment has been used, for example, as a material of a black pattern which constitutes a black matrix of a color filter for displays or a light shielding material in a CMOS camera module. As a method for forming the black pattern, a photolithography method using a UV-curable black organic composition which contains a UV-curable resin and the insulating black pigment has been known. In the photolithography method, a photoresist film is formed by applying the UV-curable black organic composition onto a base plate. Next, the photoresist film is exposed to UV rays in a patterned manner to form a pattern including a cured portion which is exposed and cured an uncured portion which is unexposed. Thereafter, the uncured portion is removed to form the black pattern. The insulating black pigment used in the formation of the black pattern according to the photolithography method is required to transmit UV rays for curing the photoresist film, that is, to have UV transmitting property.

As the insulating black pigment having UV transmitting property, zirconium nitride particles have been known (Patent Document 1). Patent Document 1 discloses, as a method for producing the zirconium nitride particles, a method of sintering a mixture which contains zirconium dioxide powder or silica-coated zirconium dioxide powder, metallic magnesium powder, and magnesium nitride powder under an atmosphere of nitrogen gas alone, a mixture gas of nitrogen gas and hydrogen gas, or a mixture gas of nitrogen gas and ammonia gas at a temperature of 650° C. to 900° C.

### CITATION LIST

### Patent Document

[Patent Document 1]
Japanese Unexamined Patent Application, First Publication No. 2017-222559

### SUMMARY OF INVENTION

### Technical Problem

It is desirable that the zirconium nitride particles used as the insulating black pigment for the UV-curable black organic composition have high storage stability. However, in a case where the zirconium nitride particles are stored in the atmospheric air for a long period of time, visible light shielding properties of the zirconium nitride particles may decrease.

The present invention has been made in consideration of the above-mentioned circumstances, and an objective of the present invention is to provide zirconium nitride particles in which visible light shielding properties are not easily deteriorated even in a case of being stored in the atmospheric air for a long period of time. Another objective of the present invention is to provide a UV-curable black organic composition which has high sensitivity to UV rays and has high visible light shielding properties even in a case of being stored in the atmospheric air for a long period of time.

### Solution to Problem

In order to solve the above-described problem, the coated zirconium nitride particle according to an aspect of the present invention contains zirconium nitride particles, an oxide layer covering at least a part of a surface of the zirconium nitride particles and fine carbon particles scattered on at least one of a surface of the oxide layer or an inside of the oxide layer, in which a content of a surface-adhered carbon is in a range of 0.10% by mass or more and 5.0% by mass or less.

The “surface-adhered carbon” in the present aspect means carbon contained in the fine carbon particles scattered on the surface of the oxide layer and/or in the oxide layer.

In addition, the “content of a surface-adhered carbon” in the present aspect means a ratio of the total mass of the surface-adhered carbon to a mass of the coated zirconium nitride particle.

In the coated zirconium nitride particle having the above-described configuration, the oxide layer covers at least a part of the surface of the zirconium nitride particles, and the fine carbon particles are scattered on at least one of the surface of the oxide layer or the inside of the oxide layer. An oxide has higher stability against moisture as compared with a nitride. In addition, the fine carbon particles have higher water repellency as compared with the oxide. Since the content of the surface-adhered carbon is in a range of 0.10% by mass or more and 5.0% by mass or less, water repellency of the oxide layer is improved by the fine carbon particles. Therefore, the zirconium nitride particles are less likely to come into contact with moisture in the atmospheric air, and are less likely to be degraded by the moisture even in a case of being stored in the atmospheric air for a long period of time. As a result, according to the coated zirconium nitride particle having the above-described configuration, UV transmitting property and visible light shielding properties are maintained in a high state even in the case of being stored in the atmospheric air for a long period of time.

Here, the coated zirconium nitride particle according to the aspect of the present invention may have a configuration in which a thickness of the oxide layer is in a range of 5 nm or more and 40 nm or less.

In this case, since the thickness of the oxide layer is in the range of 5 nm or more and 40 nm or less, moisture is less likely to enter the zirconium nitride particles, and degeneration of the zirconium nitride particles due to the moisture is even less likely to occur. As a result, UV transmitting property and visible light shielding properties are maintained in a higher state even in a case of being stored in the atmospheric air for a long period of time.

Here, the coated zirconium nitride particle according to the aspect of the present invention may have a configuration in which a ratio of a transmittance at wavelength of 365 nm to a transmittance at wavelength of 600 nm, which are measured by the following method, is 3.0 or more.

### (Measuring Method)

The coated zirconium nitride particles are allowed to stand for 72 hours in an environment of a temperature of 30° C. and a relative humidity of 90% RH. The coated zirconium nitride particles after standing are dispersed in propylene glycol monomethyl ether acetate (PGMEA) to prepare a dispersion having a concentration of 50 ppm by mass. A ratio of a transmittance at wavelength of 365 nm to a transmittance at wavelength of 600 nm is measured with the prepared dispersion.

In this case, since the zirconium nitride particles are coated with the oxide layer in a state in which the ratio of the transmittance at wavelength of 365 nm to the transmittance at wavelength of 600 nm, which are measured by the above-described method, is 3.0 or more, degeneration of the zirconium nitride particles due to moisture is even less likely to occur. As a result, in the coated zirconium nitride particle, UV transmitting property and visible light shielding properties are maintained in higher state even in the case of being stored in the atmospheric air for a long period of time.

The UV-curable black organic composition according to an aspect of the present invention is a UV-curable black organic composition containing a UV-curable organic material and a black pigment dispersed in the UV-curable organic material, in which the black pigment is the above-described coated zirconium nitride particle.

In the coated zirconium nitride particle used in the UV-curable black organic composition having the above-described configuration, since the zirconium nitride particles are less likely to be degraded by moisture, UV transmitting property and visible light shielding properties are not easily deteriorated even in a case of being stored in the atmospheric air for a long period of time. As a result, according to the UV-curable black organic composition having the above-described configuration, sensitivity to UV rays is high and visible light shielding properties are high even in the case of being stored in the atmospheric air for a long period of time.

Here, the UV-curable black organic composition according to the aspect of the present invention may have a configuration in which the UV-curable organic material is at least one organic material selected from the group consisting of an acrylic monomer, an acrylic oligomer, an epoxy monomer, and an epoxy oligomer.

In this case, since the acrylic monomer, acrylic oligomer, epoxy monomer, and epoxy oligomer have high reactivity with UV rays, the sensitivity of the UV-curable black organic composition to UV rays is higher.

### Advantageous Effects of Invention

According to the present invention, it is possible to provide zirconium nitride particles in which visible light shielding properties are not easily deteriorated even in a case of being stored in the atmospheric air for a long period of time. In addition, according to the present invention, it is possible to provide a UV-curable black organic composition which has high sensitivity to UV rays and has high visible light shielding properties even in a case of being stored in the atmospheric air for a long period of time.

### BRIEF DESCRIPTION OF DRAWINGS

FIG. 1 is a cross-sectional view of the coated zirconium nitride particle according to an embodiment of the present invention.

FIG. 2A is an STEM image of coated zirconium nitride particle obtained in Inventive Example 1.

FIG. 2B is an element distribution image of zirconium contained in the coated zirconium nitride particles obtained in Inventive Example 1.

FIG. 2C is an element distribution image of nitrogen contained in the coated zirconium nitride particles obtained in Inventive Example 1.

FIG. 2D is an element distribution image of oxygen contained in the coated zirconium nitride particles obtained in Inventive Example 1.

FIG. 2E is an element distribution image of carbon contained in the coated zirconium nitride particles obtained in Inventive Example 1.

### DESCRIPTION OF EMBODIMENTS

Hereinafter, the coated zirconium nitride particle and UV-curable black organic composition according to the embodiment of the present invention will be described with reference to the accompanying drawings.

### (Coated Zirconium Nitride Particle)

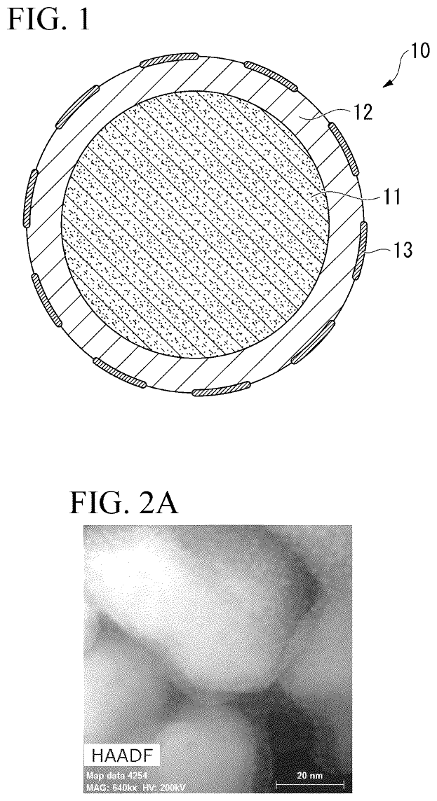

FIG. 1 is a cross-sectional view of the coated zirconium nitride particle according to the embodiment of the present invention. As shown in FIG. 1, coated zirconium nitride particle 10 according to the present embodiment contain zirconium nitride particles 11, an oxide layer (12) covering at least a part of a surface of the zirconium nitride particles 11, and fine carbon particles 13 scattered on a surface of the oxide layer 12. The fine carbon particles 13 may be scattered in the oxide layer 12.

An average primary particle diameter of the coated zirconium nitride particles may be in a range of 20 nm or more and 270 nm or less. The average primary particle diameter of the coated zirconium nitride particles 10 is more preferably in a range of 40 nm or more and 250 nm or less, and particularly preferably in a range of 40 nm or more and 150 nm or less. The average primary particle diameter of the coated zirconium nitride particles 10 is an average value of Feret diameters measured by observing 100 particles with a scanning transmission electron microscope (STEM). Here, the Feret diameter of the coated zirconium nitride particles is measured as follows. First, a mixed solution is obtained by mixing 0.5 parts by mass of the coated zirconium nitride particles and 0.1 parts by mass of an amine-based dispersant in 99.4 parts by mass of toluene. Next, the mixed solution is subjected to a dispersion treatment with a bead mill using zirconia beads having a diameter of 0.5 mm to obtain a dispersion of the coated zirconium nitride particles. Next, the dispersion is dropped on a copper mesh and dried to obtain a sample for STEM observation. The obtained sample is observed with STEM to measure the Feret diameter.

The coated zirconium nitride particle 10 contain zirconium, nitrogen, and oxygen as main component elements. The coated zirconium nitride particle 10 may contain magnesium, chlorine, or hafnium as an element other than the nitrogen, zirconium, and oxygen. A content of the magnesium may be in a range of 0.1% by mass or more and 5.0% by mass or less. A content of the chlorine may be in a range of 1 ppm by mass or more and 5,000 ppm by mass or less. A content of the hafnium may be in a range of 0.1% by mass or more and 5.0% by mass or less.

The zirconium nitride particles 11 have relatively larger contents of zirconium and nitrogen as compared with the oxide layer 12. For example, the zirconium nitride particles 11 contain 15 atm % or more of each of zirconium and nitrogen, in which an atom number concentration ratio (O/N ratio) between oxygen (O) and nitrogen (N) is 1.0 or less.

The oxide layer 12 has a relatively larger content of oxygen as compared with the zirconium nitride particles 11. For example, the oxide layer 12 has an O/N ratio of more than 1.0. The oxide layer 12 may contain a zirconium oxide (ZrO, ZrO₂, Zr₂O₃, or the like) or a zirconium oxynitride (ZrON). A thickness of the oxide layer 12 may be in a range of 5 nm or more and 40 nm or less or may be in a range of 10 nm or more and 40 nm or less. The thickness of the oxide layer 12 can be determined by observing a particle shape with a scanning transmission microscope (STEM) and performing elemental analysis with an energy dispersive X-ray spectrometer (EDS). Specifically, from a particle shape obtained by an STEM image and elemental analysis with EDS on an arbitrary line drawn from a center of the particle toward a peripheral direction, a region where zirconium and nitrogen are each detected at 15 atm % or more and the O/N ratio is 1.0 or less is defined as the zirconium nitride particles 11, a region where zirconium is detected at 5 atm % or more and the O/N ratio is more than 1.0 is defined as the oxide layer 12, and thicknesses of the oxide layer 12 at 10 arbitrary locations for one particle are measured. The thicknesses of the oxide layer 12 are measured for 10 particles, and an average thereof is defined as the thickness of the oxide layer 12. In addition, a ratio of doubled value of the thickness of the oxide layer 12 to the average primary particle diameter of the coated zirconium nitride particles 10 (double value of the thickness of the oxide layer/the average primary particle diameter) may be in a range of 0.1 or more and 0.7 or less, or may be in a range of 0.3 or more and 0.7 or less. The double value of the thickness of the oxide layer/the average primary particle diameter is an index showing the ratio of the oxide layer 12 in the coated zirconium nitride particles 10.

The content of the surface-adhered carbon in the coated zirconium nitride particle can be measured by, for example, a combustion-infrared absorption method. The coated zirconium nitride particle do not substantially contain carbonate. Therefore, the content of the surface-adhered carbon determined by the measurement is substantially the content of the fine carbon particles 13.

In the coated zirconium nitride particle 10, a ratio (T_{365 nm}/T_{600 nm}) of transmittance at wavelength of 356 nm (T_{365 nm}) (light in the UV region) to transmittance at wavelength of 600 nm (T_{600 nm}) (light in the visible light region), which are measured by the following method, may be 3.0 or more. T_{365 nm}/T_{600 nm} may be 8.0 or less.

### (Measuring Method)

The coated zirconium nitride particles are allowed to stand for 72 hours in an environment of a temperature of 30° C. and a relative humidity of 90% RH. The coated zirconium nitride particles after standing are dispersed in PGMEA to prepare a dispersion having a concentration of 50 ppm by mass. The prepared dispersion is placed in a quartz cell with an optical path length of 10 mm, a transmittance spectrum is obtained using a spectrophotometer, and a ratio of transmittance at wavelength of 365 nm to transmittance at wavelength of 600 nm in the obtained transmittance spectrum is measured.

The transmittance at wavelength of 600 nm (T_{600 nm}), which is obtained by the above-described measurement method, indicates visible light transmitting property. Therefore, it is preferable that T_{600 nm} is low. T_{600 nm} is preferably 10% or less and more preferably 5% or less. T_{600 nm} may be 1% or more. In addition, the transmittance at wavelength of 356 nm (T_{365 nm}) indicates UV transmitting property. Therefore, it is preferable that T_{365 nm} is high. For example, T_{365 nm} may be 10% or more. T_{365 nm} may be 50% or less.

In the coated zirconium nitride particles before being allowed to stand in an environment of a temperature of 65° C. and a relative humidity of 90% RH, the ratio (T_{365 nm}/T_{600 nm}) of transmittance (T_{365 nm}) at wavelength of 365 nm to transmittance (T_{600 nm}) at wavelength of 600 nm, which are measured by the above-described method, may be 2.0 or more.

For example, the coated zirconium nitride particles 10 according to the present embodiment can be produced by heating a mixture containing the zirconium nitride particles 11 and carbon fine particles in the atmospheric air at a temperature of, for example, 100° C. or higher and 300° C. or lower. As the carbon fine particles, carbon black or graphite can be used. By heating the mixture containing the zirconium nitride particles 11 and carbon fine particles in the atmospheric air at the temperature, zirconium nitride on the surface of the zirconium nitride particles 11 is oxidized to form the oxide layer 12 containing zirconium oxide or zirconium oxynitride, and simultaneously, the carbon fine particles are incorporated into the surface or inside of the oxide layer 12 to generate the fine carbon particles 13. Resin fine particles containing carbon as a main component may be used instead of the carbon fine particles. As the resin fine particles, fine particles of an epoxy resin, a melamine resin, an acrylic resin, a polyimide resin, or the like are exemplary examples.

The coated zirconium nitride particles 10 according to the present embodiment can also be produced as follows.

A raw material mixture containing zirconium dioxide powder, metallic magnesium powder, magnesium oxide powder, and carbon fine particles is charged into a heat-resistant container, placed in a heating furnace, and sintered in a nitrogen-containing gas atmosphere. As a result, a mixture containing the zirconium nitride particles 11 and the fine carbon particles 13 is produced. As the heating furnace, an electric furnace can be used. As the zirconium dioxide powder, zirconium dioxide powder coated with silica may be used. In the raw material mixture, with respect to 1 mol of a content of the zirconium dioxide powder, a content of the metallic magnesium powder may be in a range of 2.0 mol or more and 6.0 mol or less, and a content of the magnesium nitride powder may be in a range of 0.3 or more and 3.0 mol or less. As the nitrogen-containing gas, for example, nitrogen gas alone, a mixture gas of nitrogen gas and hydrogen gas, or a mixture gas of nitrogen gas and ammonia gas can be used. A sintering temperature is, for example, in a range of 650° C. or higher and 900° C. or lower. In this case, in a case where a carbon crucible is used as the heat-resistant container, as a carbon source of the fine carbon particles 13, carbon in the carbon crucible is also incorporated in addition to the carbon fine particles in the raw material mixture. In addition, since a reaction between zirconium dioxide and metallic magnesium is accompanied by an instantaneous and locally strong heat generation, the carbon fine particles and the carbon crucible are partially thermally decomposed into fine particles. Carbon formed into fine particles is also incorporated as the carbon source of the fine carbon particles 13. After being sintered, the raw material mixture may be allowed to be cooled to room temperature. During the cooling, the zirconium nitride particles 11 produced by the sintering may be released into the atmospheric air in a case where the temperature inside the heating furnace is in a range of 100° C. or higher and 300° C. or lower. By doing so, zirconium nitride on the surface of the zirconium nitride particles 11 is oxidized to form the oxide layer 12, and simultaneously, carbon is incorporated into the surface or inside of the oxide layer 12 to generate the fine carbon particles 13. Same as described above, fine particles of an epoxy resin, a melamine resin, an acrylic resin, a polyimide resin, or the like may be used instead of the carbon fine particles.

In the coated zirconium nitride particles 10 according to the present embodiment, having such a configuration, the oxide layer 12 covers at least a part of the surface of the zirconium nitride particles 11, and the fine carbon particles 13 are scattered on at least one of the surface of the oxide layer 12 or the inside of the oxide layer 12. An oxide has higher stability against moisture as compared with a nitride. In addition, the fine carbon particles 13 have higher water repellency as compared with the oxide. Since the content of the surface-adhered carbon is in a range of 0.1% by mass or more and 5.0% by mass or less, water repellency of the oxide layer is improved by the fine carbon particles. Therefore, in the coated zirconium nitride particles 10 according to the present embodiment, the zirconium nitride particles 11 are less likely to come into contact with moisture, and are less likely to be degraded by the moisture even in a case of being stored in the atmospheric air for a long period of time. As a result, UV transmitting property and visible light shielding properties are maintained in a high state even in a case of being stored in the atmospheric air for a long period of time.

In addition, in the coated zirconium nitride particles 10 according to the embodiment of the present invention, in a case where the thickness of the oxide layer 12 is in the range of 5 nm or more and 40 nm or less, moisture is less likely to enter the zirconium nitride particles 11, and degeneration of the zirconium nitride particles 11 due to the moisture is even less likely to occur. As a result, UV transmitting property and visible light shielding properties are maintained in a higher state even in a case of being stored in the atmospheric air for a long period of time.

In addition, in the coated zirconium nitride particles 10 according to the present embodiment, in a case where the zirconium nitride particles 11 are coated with the oxide layer 12 in a state in which the ratio (T_{365 nm}/T_{600 nm}) of the transmittance at wavelength of 356 nm (T_{365 nm}) to the transmittance at wavelength of 600 nm (T_{600 nm}), which are measured by the above-described method, is 3.0 or more, degeneration of the zirconium nitride particles 11 due to moisture is even less likely to occur. As a result, UV transmitting property and visible light shielding properties are maintained in a higher state even in a case of being stored in the atmospheric air for a long period of time.

### (UV-Curable Black Organic Composition)

The UV-curable black organic composition is a composition containing a UV-curable organic material and a black pigment dispersed in the UV-curable organic material. As the black pigment, the above-described coated zirconium nitride particles are used.

As the UV-curable organic material, a monomer or an oligomer, which is polymerized by being irradiated with UV rays to generate a polymer, can be used. As examples of the UV-curable organic material, an acrylic monomer, an acrylic oligomer, an epoxy monomer, and an epoxy oligomer can be exemplary examples. These organic materials may be used alone or in combination of two or more kinds thereof.

The acrylic monomer is a monomer having a (meth)acryloyl group. The (meth)acryloyl group includes an acryloyl group and a methacryloyl group. The acrylic monomer may be a monofunctional acrylic monomer having one (meth)acrylic group in one molecule, or may be a polyfunctional acrylic monomer having two or more (meth)acrylic groups in one molecule. As the monofunctional (meth)acrylic monomer, (meth)acrylic acid, methyl (meth)acrylate, ethyl (meth)acrylate, propyl (meth)acrylate, n-butyl (meth)acrylate, isobutyl (meth)acrylate, 2-ethylhexyl (meth)acrylate, octyl (meth)acrylate, isooctyl (meth)acrylate, isodecyl (meth)acrylate, lauryl (meth)acrylate, stearyl (meth)acrylate, benzyl (meth)acrylate, phenyl (meth)acrylate, phenoxyethyl (meth)acrylate, 2-hydroxyethyl (meth)acrylate, 2-hydroxypropyl (meth)acrylate, isoamyl acrylate, tetrahydrofurfuryl (meth)acrylate, isobornyl (meth)acrylate, and the like are exemplary examples. As a difunctional (meth)acrylic monomer, 1,6-hexanediol di(meth)acrylate, 1,9-nonanediol di(meth)acrylate, neopentyl glycol di(meth)acrylate, polyethylene glycol di(meth)acrylate, ethylene oxide-modified bisphenol A di(meth)acrylate, neopentyl triethylene glycol di(meth)acrylate, and the like are exemplary examples. As the polyfunctional (meth)acrylic monomer, pentaerythritol tri(meth)acrylate, pentaerythritol tetra(meth)acrylate, trimethylolpropane tri(meth)acrylate, and the like are exemplary examples.

The acrylic oligomer is a low-molecular-weight polymer obtained by polymerizing the acrylic monomer, and acrylic acrylate, urethane acrylate, epoxy acrylate, polyester acrylate, and the like are exemplary examples. A molecular weight of the acrylic oligomer may be, for example, in a range of 1,000 or more and 10,000 or less in terms of a number-average molecular weight. These (meth)acrylate monomers and oligomers can be used alone or in combination of two or more kinds thereof. In addition, the (meth)acrylic monomer and oligomer are not limited to those described above, and a generally known (meth)acrylic monomer and oligomer can be used.

The epoxy monomer is a monomer having an epoxy group. The epoxy monomer may be a monofunctional epoxy monomer having one epoxy group in one molecule, or may be a polyfunctional epoxy monomer having two or more epoxy groups in one molecule. As the epoxy monomer, glycidyl ether, alicyclic epoxy, and the like are exemplary examples.

The epoxy oligomer is a low-molecular-weight polymer obtained by polymerizing the epoxy monomer. A molecular weight of the epoxy oligomer may be, for example, in a range of 1,000 or more and 10,000 or less in terms of a number-average molecular weight.

The UV-curable black organic composition may contain another UV-curable organic material. As another UV-curable organic material, for example, a styrene-based monomer, a vinyl-based monomer, a cationic curable monomer, or the like can be used. As examples of the styrene-based monomer, styrene, vinyl toluene, and divinyl benzene can be exemplary examples. As examples of the vinyl-based monomer, vinyl chloride and vinyl acetate can be exemplary examples. As examples of the cationic curable monomer, oxetane can be exemplary examples.

The UV-curable black organic composition may contain a plasticizer. As examples of the plasticizer, for example, a phosphoric acid ester-based plasticizer, a phthalic acid ester-based plasticizer, an aliphatic-basic ester-based plasticizer, an aliphatic dibasic acid ester-based plasticizer, a divalent alcohol ester-based plasticizer, or an oxy acid ester-based plasticizer can be used. As examples of the phosphoric acid ester-based plasticizer, tributyl phosphate and 2-ethylhexyl phosphate can be exemplary examples. As examples of the phthalic acid ester-based plasticizer, dimethyl phthalate and dibutyl phthalate can be exemplary examples. As examples of the aliphatic-basic ester-based plasticizer, butyl oleate and glycerin monooleic acid ester can be exemplary examples. As examples of the aliphatic dibasic acid ester-based plasticizer, dibutyl adipate and di-2-ethylhexyl sebacate can be exemplary examples. As examples of the divalent alcohol ester-based plasticizer, diethylene glycol dibenzoate and triethylene glycol di-2-ethyl butyrate can be exemplary examples. As examples of the oxy acid ester-based plasticizer, methyl acetylricinoleate and tributyl acetylcitrate can be exemplary examples.

The UV-curable black organic composition may contain a photopolymerization initiator. The photopolymerization initiator is preferably a compound capable of absorbing UV rays, specifically, light having a wavelength of 100 to 400 nm and initiating a photopolymerization reaction. The photopolymerization initiator may be, for example, a radical generator or a photoacid generator. As the photopolymerization initiator, for example, an acetophenone-based compound, a benzophenone-based compound, a benzoin ether-based, a triazine compound, a phosphine oxide-based compound, a sulfonium-based compound, or an organic peroxide can be used. As examples of the acetophenone-based compound, acetophenone, dimethylacetophenone, and 2-hydroxy-2-methylpropiophenone can be exemplary examples. As examples of the benzophenone-based compound, benzophenone and 2-chlorobenzophenone can be exemplary examples. As examples of the phosphine oxide-based compound, bis(2,4,6-trimethylbenzoyl)phenylphosphine oxide and 2,4,6-trimethylbenzoyl-diphenylphosphine oxide can be exemplary examples. As examples of the sulfonium-based compound, bis(4-tert-butylphenyl)iodonium hexafluorophosphate, triphenylsulfonium tetrafluoroborate, tri-p-tolylsulfonium trifluoromethanesulfonate, and the like can be exemplary examples. As examples of the organic peroxide, benzoyl peroxide and cumene peroxide can be exemplary examples.

A content of the photopolymerization initiator in the UV-curable black organic composition is preferably in a range of 0.5 parts by mass or more and 15 parts by mass or less with respect to 100 parts by mass of the UV-curable organic material.

A content of the UV-curable organic material in the UV-curable black organic composition is preferably in a range of 50% by mass or more and 90% by mass or less with respect to solid contents of the UV-curable black organic composition. In a case where the content of the UV-curable organic material is within the range, shielding properties of a black pattern to be obtained tend to be improved. The content of the UV-curable resin is more preferably in a range of 55% by mass or more and 85% by mass or less, and particularly preferably in a range of 60% by mass or more and 80% by mass or less. A content of the coated zirconium nitride particles in the UV-curable black organic composition is preferably in a range of 0.1% by mass or more and 50% by mass or less with respect to solid contents of the UV-curable black organic composition. In a case where the content of the coated zirconium nitride particles is within the range, it is possible to improve the visible light shielding properties and the UV transmitting property in a well-balanced manner. The content of the coated zirconium nitride particles is more preferably in a range of 5% by mass or more and 45% by mass or less, and particularly preferably in a range of 20% by mass or more and 40% by mass or less.

The UV-curable black organic composition may contain a solvent. As examples of the solvent, for example, ethyl carbitol, ethyl carbitol acetate, butyl carbitol acetate (BCA), butyl carbitol, methyl cellosolve, ethyl cellosolve, glycol ethers such as diethylene glycol ethyl methyl ether, propylene glycol monomethyl ether, propylene glycol monomethyl ether acetate (PGMEA), propylene glycol monoethyl ether, dipropylene glycol monomethyl ether, dipropylene glycol monoethyl ether, triethylene glycol monomethyl ether, and triethylene glycol monoethyl ether, α-terpineol, methyl ethyl ketone (MEK), ethyl acetate, butyl acetate, n-propanol, isopropanol, methanol, ethanol, toluene, water, and the like can be exemplary examples. A content of the solvent is preferably in a range of 0% by mass or more and 60% by mass or less with respect to the UV-curable black organic composition. In a case where the content of the solvent is within the range, coating properties of the UV-curable black organic composition are improved, and a film thickness of a photoresist film to be formed on a base plate tends to be uniform. The content of the solvent is more preferably in a range of 5% by mass or more and 50% by mass or less, and particularly preferably in a range of 10% by mass or more and 40% by mass or less.

In the coated zirconium nitride particle 10 used in the UV-curable black organic composition according to the present embodiment, having such a configuration, since the zirconium nitride particles 11 are less likely to be degraded by moisture, UV transmitting property and visible light shielding properties are high even in a case of being stored in the atmospheric air for a long period of time. As a result, in the UV-curable black organic composition according to the present embodiment, sensitivity to UV rays is high and visible light shielding properties are high even in the case of being stored in the atmospheric air for a long period of time.

In the UV-curable black organic composition according to the present embodiment, in a case where the UV-curable organic material is at least one organic material selected from the group consisting of an acrylic monomer, an acrylic oligomer, an epoxy monomer, and an epoxy oligomer, since these organic materials have high reactivity with UV rays, the sensitivity of the UV-curable black organic composition to UV rays is higher.

The embodiment of the present invention has been described above, but the present invention is not limited thereto and can be appropriately modified without departing from the technical idea of the invention.

### EXAMPLES

### Inventive Example 1

9.5 g of zirconium oxide (ZrO₂) powder having an average primary particle diameter of 53 nm, 5.83 g of Mg powder, 3.39 g of MgO powder, and 0.05 g of carbon black powder (average particle diameter: 50 nm) were each weighed, and mixed with each other in a nitrogen gas atmosphere to obtain a raw material mixture. The average primary particle diameters of the zirconium oxide and the carbon black were measured in the same manner as the average primary particle diameter of the coated zirconium nitride particles described later. The obtained raw material mixture was put into a carbon crucible, and the carbon crucible was placed in an electric furnace. Next, while supplying nitrogen gas into the electric furnace, the raw material mixture was heated under a condition of furnace temperature of 700° C. for 1 hour to carry out a reduction and nitriding reaction and generate zirconium nitride particles. Thereafter, the electric furnace was allowed to be cooled, and at a time when the temperature inside the furnace reached 110° C., the supply of nitrogen gas was stopped. Next, a door of the electric furnace was opened, and the inside of the electric furnace was released to the atmospheric air to generate coated zirconium nitride particles. The inside of the electric was released to the atmospheric air until the temperature inside the electric furnace reached near room temperature (30° C.), and then the coated zirconium nitride particles were collected from the electric furnace. The collected coated zirconium nitride particles were dispersed in 300 g of an aqueous hydrochloric acid solution having a concentration of 5% to dissolve and remove impurities. Next, an operation of neutralizing the aqueous hydrochloric acid solution with an aqueous ammonia solution, removing the supernatant decantation, and adding water was carried out several times to obtain a coated zirconium nitride particle slurry. The obtained coated zirconium nitride particle slurry was filtered, and the recovered coated zirconium nitride particles were washed with pure water and dried to obtain coated zirconium nitride (ZrN) powder. The obtained coated zirconium nitride powder was sealed and stored in an environment of a temperature of 25° C. and a relative humidity of 20% RH or less.

With the obtained coated zirconium nitride particles, an average primary particle diameter, the presence or absence of fine carbon particles, a thickness of the oxide layer, a content of the surface-adhered carbon, and optical characteristics before and after storage were measured as follows. The results thereof are shown in Table 1 later.

### (Average Primary Particle Diameter)

A mixed solution was obtained by charging and mixing 0.5 parts by mass of the coated zirconium nitride particles and 0.1 parts by mass of an amine-based dispersant in 99.4 parts by mass of toluene. Next, the obtained mixed solution was dispersed and crushed with a bead mill using zirconia beads having a diameter of 0.5 mm to a toluene dispersion of the coated zirconium nitride particles. Next, the dispersion was dropped on a copper mesh and dried to obtain a sample for STEM observation. Using STEM (manufactured by Thermo Fisher Scientific Inc., Titan G2 ChemiSTEM), the obtained sample was observed at an acceleration voltage of 200 kV, Feret diameters of 100 particles were measured, and an average thereof was calculated.

### (Presence or Absence of Fine Carbon Particles and Thickness of Oxide Layer)

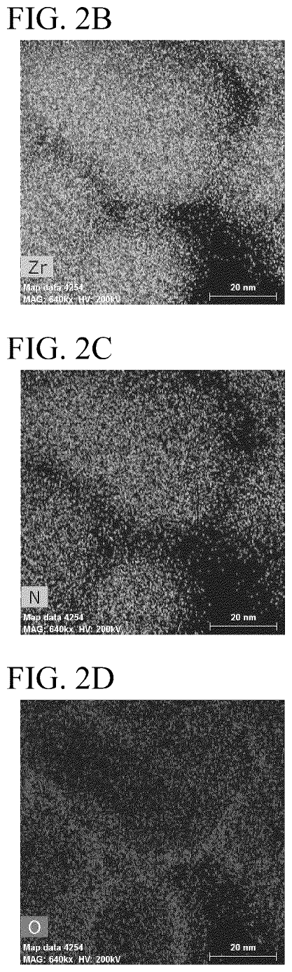

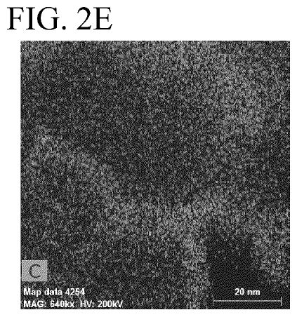

With the obtained zirconium nitride particles, observation of particle shape with STEM and elemental analysis with EDS (manufactured by Thermo Fisher Scientific Inc., Velox) were carried out. The results thereof are shown in FIGS. 2A to 2E. FIG. 2A is an STEM image (HAADF image), FIG. 2B is an element distribution image of zirconium (Zr), FIG. 2C is an element distribution image of nitrogen (N), FIG. 2D is an element distribution image of oxygen (O), and FIG. 2E is an element distribution image of carbon (C). From the results of FIG. 2, it was found that oxygen and carbon were distributed in layers on the surface of the coated zirconium nitride particles. From the results, it was confirmed that the coated zirconium nitride particles were particles in which the oxide layer was formed on the surface of the zirconium nitride particles, and the fine carbon particles were scattered on at least the surface of the oxide layer. Thicknesses of the oxide layer at 10 arbitrary locations for one coated zirconium nitride particle were measured. The thicknesses of the oxide layer 12 were measured for 10 particles, and an average thereof was defined as the thickness of the oxide layer. Furthermore, a ratio of doubled value of the thickness of the oxide layer to the average primary particle diameter of the coated zirconium nitride particles (double value of the thickness of the oxide layer/the average primary particle diameter) was calculated.

### (Content of Surface-Adhered Carbon)

With the obtained coated zirconium nitride particles, using a carbon and sulfur analyzer (manufactured by HORIBA, Ltd., EMIA-810W), the content of the surface-adhered carbon in the coated zirconium nitride particles was determined by a combustion-infrared absorption method in an oxygen stream. Measurement conditions were set to a specimen amount of 0.2 g, a combustion temperature of 1100° C., and a measurement time of 80 seconds.

### (Optical Characteristics Before Storage)

10 parts by mass of the obtained coated zirconium nitride particles, 1 part by mass of an amine-based dispersant, and 29 parts by mass of PGMEA were mixed with each other, and the obtained mixture was subjected to a dispersion treatment with a bead mill. PGMEA was added to the mixture after the dispersion treatment, and the mixture was stirred and mixed to dilute the dispersion, thereby preparing a dispersion having a concentration of 50 ppm by mass. The obtained dispersion was injected into a quartz cell with an optical path length of 10 mm, and using a spectrophotometer (UH-4150 manufactured by Hitachi High-Tech Corporation), light transmittance was measured in a wavelength range of 240 nm to 1300 nm to obtain a spectral curve. From the obtained spectral curve, transmittance at wavelength of 356 nm (T_{365 nm}) and transmittance at wavelength of 600 nm (T_{600 nm}) were read, and a ratio (T_{365 nm}/T_{600 nm}) of the transmittance at wavelength of 365 nm to the transmittance at wavelength of 600 nm was calculated. As a result, T_{365 nm} was 14.5%, T_{600 nm} was 3.1%, and T_{365 nm}/T 600 nm was 4.7.

(Optical Characteristics after Storage)

10 g of the obtained coated zirconium nitride particles was placed in a petri dish, placed into a constant temperature and constant humidity tank, and left to stand for 72 hours under conditions of a temperature of 65° C. and a relative humidity of 90% RH for storage. In the same manner as described above, a dispersion having a concentration of 50 ppm by mass was prepared with the coated zirconium nitride particles after the storage, the spectral curve was obtained, T_{365 nm} and T_{600 nm} were read, and T_{365 nm}/T_{600 nm} was calculated. As a result, T_{365 nm} was 20.1%, T_{600 nm} was 4.9%, and T_{365 nm}/T_{600 nm} was 4.1.

### INVENTIVE EXAMPLES 2 TO 14 AND COMPARATIVE EXAMPLES 1 AND 2

Coated zirconium nitride particles were obtained in the same manner as in Inventive Example 1, except that, with regard to the zirconium oxide powder as the raw material, powder having an average primary particle diameter listed in Table 1 was used, and the blending amount of carbon black and the atmospheric release temperature at which the inside of the electric furnace was released to the atmospheric air during cooling after generating the zirconium nitride particles in the electric furnace were set to values listed in Table 1. With the obtained zirconium nitride particles, in the same manner as in Inventive Example 1, the average primary particle diameter and the thickness of the oxide layer were measured, the double value of the thickness of the oxide layer/the average primary particle diameter was calculated, and the presence or absence of the fine carbon particles, the content of the surface-adhered carbon, and the optical characteristics before and after storage were measured. The results thereof are shown in Table 1.

TABLE 1

| | Production conditions of coated | | | | | | |
|---|---|---|---|---|---|---|---|
| | zirconium nitride particles | | | | | | |
| | Average | | | | | | Doubled |
| | primary | Blending | | | Presence | | value of |
| | particle | amount | | Average | or | | thickness of |
| | diameter | of carbon | Atmospheric | primary | absence | Thickness | oxide layer/ |
| | of zirconium | black | release | particle | of fine | of oxide | primary |
| | nitride | powder | temperature | diameter | carbon | layer | particle |
| | (nm) | (g) | (° C.) | (nm) | particles | (nm) | diameter |
| Inventive | 53 | 0.05 | 110 | 89 | Presence | 10 | 0.2 |
| Example 1 | | | | | | | |
| Inventive | 53 | 0.01 | 110 | 91 | Presence | 10 | 0.2 |
| Example 2 | | | | | | | |
| Inventive | 53 | 0.15 | 110 | 84 | Presence | 10 | 0.2 |
| Example 3 | | | | | | | |
| Inventive | 53 | 0.31 | 110 | 81 | Presence | 10 | 0.2 |
| Example 4 | | | | | | | |
| Inventive | 53 | 0.40 | 110 | 80 | Presence | 10 | 0.3 |
| Example 5 | | | | | | | |
| Inventive | 53 | 0.42 | 110 | 80 | Presence | 10 | 0.3 |
| Example 6 | | | | | | | |
| Inventive | 53 | 0.50 | 110 | 79 | Presence | 10 | 0.3 |
| Example 7 | | | | | | | |
| Inventive | 53 | 0.04 | 150 | 90 | Presence | 20 | 0.4 |
| Example 8 | | | | | | | |
| Inventive | 80 | 0.08 | 150 | 104 | Presence | 20 | 0.4 |
| Example 9 | | | | | | | |
| Inventive | 102 | 0.05 | 260 | 141 | Presence | 33 | 0.5 |
| Example 10 | | | | | | | |
| Inventive | 53 | 0.12 | 30 | 88 | Presence | 5 | 0.1 |
| Example 11 | | | | | | | |
| Inventive | 20 | 0.22 | 30 | 47 | Presence | 5 | 0.2 |
| Example 12 | | | | | | | |
| Inventive | 53 | 0.01 | 30 | 90 | Presence | 5 | 0.1 |
| Example 13 | | | | | | | |
| Inventive | 53 | 0.51 | 30 | 80 | Presence | 5 | 0.1 |
| Example 14 | | | | | | | |
| Comparative | 53 | Not | 30 | 92 | Presence | 5 | 0.1 |
| Example 1 | | added | | | | | |
| Comparative | 53 | 0.55 | 30 | 78 | Presence | 5 | 0.1 |
| Example 2 | | | | | | | |

| | Content | | | | | | |
|---|---|---|---|---|---|---|---|
| | of | | | | | | |
| | surface- | | | | | | |
| | adhered | Optical characteristics | | | Optical characteristics | | |
| | carbon | before storage | | | after storage | | |
| | (% by | T_{365 nm} | T_{600 nm} | | T_{365 nm} | T_{600 nm} | |
| | mass) | (%) | (%) | T_{365 nm}/T_{600 nm} | (%) | (%) | T_{365 nm}/T_{600 nm} |
| Inventive | 0.50 | 14.5 | 3.1 | 4.7 | 20.1 | 4.9 | 4.1 |
| Example 1 | | | | | | | |
| Inventive | 0.12 | 14.7 | 3.2 | 4.6 | 23.3 | 6.0 | 3.9 |
| Example 2 | | | | | | | |
| Inventive | 1.50 | 13.4 | 3.0 | 4.5 | 20.0 | 4.9 | 4.1 |
| Example 3 | | | | | | | |
| Inventive | 3.00 | 12.1 | 2.9 | 4.2 | 15.1 | 3.8 | 4.0 |
| Example 4 | | | | | | | |
| Inventive | 3.80 | 11.5 | 2.9 | 4.0 | 13.6 | 3.6 | 3.8 |
| Example 5 | | | | | | | |
| Inventive | 4.10 | 11.2 | 2.8 | 4.0 | 12.8 | 3.5 | 3.7 |
| Example 6 | | | | | | | |
| Inventive | 5.00 | 10.4 | 2.8 | 3.7 | 11.1 | 3.1 | 3.6 |
| Example 7 | | | | | | | |
| Inventive | 0.42 | 14.6 | 3.4 | 4.3 | 21.2 | 5.2 | 4.1 |
| Example 8 | | | | | | | |
| Inventive | 0.83 | 14.2 | 3.2 | 4.4 | 20.9 | 5.1 | 4.1 |
| Example 9 | | | | | | | |
| Inventive | 0.50 | 27.0 | 7.8 | 3.5 | 29.4 | 8.5 | 3.5 |
| Example 10 | | | | | | | |
| Inventive | 1.10 | 13.3 | 3.1 | 4.3 | 19.6 | 4.8 | 4.1 |
| Example 11 | | | | | | | |
| Inventive | 2.10 | 12.8 | 3.2 | 4.0 | 15.8 | 4.0 | 4.0 |
| Example 12 | | | | | | | |
| Inventive | 0.10 | 14.8 | 3.1 | 4.8 | 25.2 | 7.2 | 3.5 |
| Example 13 | | | | | | | |
| Inventive | 5.00 | 10.1 | 2.8 | 3.6 | 11.0 | 3.1 | 3.5 |
| Example 14 | | | | | | | |
| Comparative | 0.04 | 15.0 | 3.2 | 4.7 | 25.9 | 10.7 | 2.4 |
| Example 1 | | | | | | | |
| Comparative | 5.20 | 9.2 | 2.7 | 3.4 | 9.3 | 3.5 | 2.7 |
| Example 2 | | | | | | | |

From the results in Table 1, it was found that the coated zirconium nitride particles obtained in Inventive Examples 1 to 10, which contained the oxide layer and the fine carbon particles scattered on the surface or the inside of the oxide layer, in which the content of the surface-adhered carbon was within the range of the present invention, the T_{365 nm}/T_{600 nm} before and after the storage indicated a value of 3.5 or more, and storage stability in the atmospheric air was excellent. This is because the fine carbon particles were scattered on at least one of the surface of the oxide layer or the inside of the oxide layer, so that water repellency of the oxide layer was improved, and thus the zirconium nitride particles were less likely to come into contact with moisture in the atmospheric air. On the other hand, in the coated zirconium nitride particles obtained in Comparative Example 1, in which the content of the surface-adhered carbon was 0.06% by mass, the T_{365 nm}/T_{600 nm} before the storage was 4.7, but the T_{365 nm}/T_{600 nm} after the storage was decreased to 3.0. This is because the surface of the zirconium nitride particles were locally hydrolyzed by moisture during the storage, and oxidation proceeded to a deep part of the particles, so that visible light shielding properties were decreased and T_{600 nm} became high. In addition, in the coated zirconium nitride particles obtained in Comparative Example 2, in which the content of carbon was 5.2% by mass, T_{365 nm} before the storage was less than 10%, and the T_{365 nm}/T_{600 nm} before the storage was 3.4. This is because the content of the fine carbon particles in the oxide layer was too large and absorbance of UV rays in the oxide layer was increased.

### INDUSTRIAL APPLICABILITY

The UV-curable black organic composition according to the present embodiment contains the coated zirconium nitride particles according to the present embodiment. Therefore, the UV-curable black organic composition according to the present embodiment can be used, for example, as a material for forming a black pattern, which is used as a black matrix of image forming elements used in displays such as a liquid crystal display and an organic EL display or as a light shielding material in image sensors such as a CMOS sensor. In addition, the UV-curable black organic composition according to the present embodiment can be used as a light shielding material of an optical member and as a material of a light shielding filter, an IR cut filter, or a cover lay film.

### REFERENCE SIGNS LIST

10: Coated zirconium nitride particle
11: Zirconium nitride particle
12: Oxide layer
13: Fine carbon particle

1. A coated zirconium nitride particle comprising:
a zirconium nitride particle;
an oxide layer covering at least a part of a surface of the zirconium nitride particle; and
fine carbon particles scattered on a surface of the oxide layer or in the oxide layer,
wherein a content of a surface-adhered carbon is in a range of 0.10% by mass or more and 5.0% by mass or less and
a thickness of the oxide layer is in a range of 5 nm or more and 40 nm or less.

2. (canceled)

3. The coated zirconium nitride particle according to claim 1,
wherein a ratio of a transmittance at wavelength of 365 nm to a transmittance at wavelength of 600 nm, which are measured by the following method, is 3.0 or more,
(measuring method) the coated zirconium nitride particles are allowed to stand for 72 hours in an environment of a temperature of 30° C. and a relative humidity of 90% RH; the coated zirconium nitride particles after standing are dispersed in propylene glycol monomethyl ether acetate to prepare a dispersion having a concentration of 50 ppm by mass; and a ratio of a transmittance at wavelength of 365 nm to a transmittance at wavelength of 600 nm is measured with the prepared dispersion.

4. A UV-curable black organic composition comprising:
a UV-curable organic material; and
a black pigment dispersed in the UV-curable organic material,
wherein the black pigment is the coated zirconium nitride particle according to claim 1.

5. The UV-curable black organic composition according to claim 4,
wherein the UV-curable organic material is at least one organic material selected from the group consisting of an acrylic monomer, an acrylic oligomer, an epoxy monomer, and an epoxy oligomer.

6. The coated zirconium nitride particle according to claim 1,
wherein a ratio of doubled value of the thickness of the oxide layer to an average primary particle diameter of the coated zirconium nitride particles is in a range of 0.1 or more and 0.5 or less.
